(19) United States
(12) Patent Application Publication
(10) Pub. No.: US 2011/0250462 A1
(43) Pub. Date: Oct. 13, 2011

(54) Multilayer, Tube-Shaped Food Film

(75) Inventor: Jurgen Schiffmann, Hennef (DE)

(73) Assignee: Kuhne Anlagenbau GmbH, St. Augustin/Menden (DE)

(21) Appl. No.: 13/140,151

(22) PCT Filed: Oct. 27, 2009
(86) PCT No.: PCT/EP2009/007682

§ 371 Date: Jun. 16, 2011

(30) Foreign Application Priority Data
Dec. 23, 2008 (DE) 10 2008 062 937.5

(51) Int. Cl. B32B 1/08; B32B 27/32; F16L 11/00; B32B 27/34

(52) U.S. Cl. 428/474.4; 138/118.1

(57) ABSTRACT

The present invention relates to a multilayer, tube-type food film, in particular sausage casing, wherein the food film is manufactured on a multilayer coextrusion film blow molding system by means of coextruded plastics supplied to a blowing head and stretched biaxially in the triple bubble process. The food film comprises at least six layers. The at least six layers of the food film are arranged from the outside to the inside, as follows: an outermost layer including a polyamide as a layer component, an innermost layer including a polyamide as a layer component, and an intermediately arranged succession of at least four intermediate layers being arranged from the outside to the inside, as follows: one layer includes an adhesion promoter as a layer component, another layer includes a polyolefin as a layer component, another layer includes a polyolefin as a layer component, and another layer includes an adhesion promoter as a layer component. The present invention further relates to a multilayer, planar food casing that is produced of a multilayer, tube-type food film cut open for this purpose.

The present invention relates to a multilayer, tube-type food film, in particular sausage casing, wherein the food film is manufactured on a multilayer coextrusion film blow molding system by means of coextruded plastics supplied to a blowing head and stretched biaxially in the triple bubble process, in accordance with the preamble of claims 1 and 6 to 13. The invention further relates to a multilayer planar food casing according to claim 19.

In practice, 1-, 3-, 5- or 7-layer tube-type films are already being utilized as a sausage casing or artificial sausage skin for packaging pasty foodstuffs. The food or victual to be packaged such as, for example, a sausage stock, is filled into the artificial sausage skin, broiled inside the latter, cooled, and stored.

The use as a food packaging results in demands to a like food film such as, e.g., a distinct dimensional stability throughout the processing process or an adequate protection of the filling material against undesirable external influences such as, e.g., entry of oxygen, UV radiation, desiccation, etc.

In addition, high demands are nowadays made to the optical appearance of food packagings and in particular of sausage casings. Thus, food packagings increasingly have a publicity character. They are intended to transport advertisement messages and exert a direct influence on the consumer's buying decision. This in turn makes it necessary for food packagings to not only present a first-class print image, but in addition to also possess optimum dyeing capability.

Thus, for example the document EP 0 467 039 B1 describes a multilayer packaging film for use as a sausage casing. This packaging casing consists of three or five layers, with the outer layer and the inner layer consisting of polyamides (in brief: PA) and the middle layer of a polymer mixture with polyolefin (in brief: PO). There it is proposed to imprint the outer PA layer and to work dyes or color pigments into the middle PO layer.

It is a drawback in this structure that the middle layer is not capable of meeting any of the demands made to it, such as an appropriate water vapor barrier, good adhesion properties with the outer PA layers, and a homogeneous dyeing capability. Thus, the water vapor barrier property of the PO is clearly reduced, in comparison with a pure PO layer, by the addition of adhesion promoters (in brief: AP) and/or color pigments. In addition, the effect of the AP which is present only in proportional amounts is considerably weaker in comparison with a pure AP layer. The addition of color pigments to the middle layer moreover brings about a further degradation of the adhesive effect. A desired dyeing capability of the middle layer may thus only be realized in a limited degree in consideration of the other requirements that are to be met.

As the inner layer is to be realized as a very thin layer, an adequate oxygen barrier is possible only conditionally or by restricting other properties in the case of this layer structure.

Apart from this, in this known sausage casing a desired, homogeneous and covering dyeing is possible only under considerable limitation of other properties such as interlayer adhesion or stock adhesion.

The document DE 43 39 337 C2 discloses an advantageous development of the 3-layer sausage casing. Its 5-layer structure comprises a respective separate AP layer between the outer/inner PA layers and the middle PO layer. The resulting 5-layer sausage casing therefore offers improved interlayer adhesion in comparison with the 3-layer version. Mention is moreover made of the good printability and adhesion of the printing inks on the other PA layer.

Other properties such as a high oxygen barrier and/or a dyeing capability of several layers can, however, not be realized sufficiently with this structure.

The document EP 1 290 948 A1 equally describes a PA-based, 3- and 5-layer sausage casing in the outer layer and inner layers. Its 5-layer version only differs from the 5-layer sausage casing of document DE 43 39 337 C2 as discussed in the foregoing in the polymers being used, particularly as regards the PO and AP layers. Thus, for the middle layer ethylene-C₁₋₈ alkylacrylate copolymers and ethylene-maleic anhydride copolymers are provided. In a 5-layer embodiment a middle layer on the basis of ethylene-ethylene-C₁₋₈ alkylacrylate copolymers is surrounded by two layers on the basis of ethylene-maleic anhydride copolymers and/or ethylene-ethylene-C₁₋₈ alkylacrylate-maleic anhydride copolymers.

It is a drawback in this layer structure that the utilized layers on the basis of ethylene-methacrylate copolymer present a lower water vapor barrier than the PO otherwise used, such as polyethylene (in brief: PE) or polypropylene (in brief: PP). It is merely an alternative solution for other 5 layer-sausage casings presenting the same limitations with regard to dyeing capability and oxygen barrier properties.

In documents DE 102 27 580 A1 and DE 102 54 172 A1 to the same applicant, 7-layer structures for food casings are described for the first time. The food casings disclosed in the document DE 102 27 580 A1 comprise as layer structures, with the delimitation of the single layers from each other being represented in the following by the symbol “∥”, from the outside to the inside:

### a) PA∥EVOH∥AP∥PO∥AP∥PA;

### b) PA∥EVOH∥PA∥AP∥PO∥AP∥PA;

### c) PA∥AP∥PA∥EVOH∥PA∥PA;

### d) PO∥AP∥PA∥EVOH∥PA∥AP∥PO;

e) polyethylene terephthalate (in brief: PET) ∥AP∥PA∥EVOH∥PA∥AP∥PO; or
f) PO∥ethylene-vinyl alcohol copolymer (in brief: EVA) ∥AP∥EVOH∥AP∥EVA∥PO.

In the document DE 102 54 172 A1 the layer structures (a) to (f) described in the foregoing are described analogously with polyvinyl alcohol (in brief: PVA) instead of EVOH.

The simplified expression “EVA”, frequently used in practice by the applicant and some experts for an ethylene-vinyl alcohol or an ethylene-vinyl alcohol copolymer, respectively, is identical with the standardized designation “EVOH” as used in the following description. The simplified expression “PVA”, also frequently usual in practice, is identical with the standardized designation “PVOH” as used in the following description.

Due to these successions of layers including an additional EVOH or PVOH layer, respectively, the oxygen barrier is clearly improved in comparison with the 5 layer-food casing. Moreover the desired mechanical properties may be achieved at least to a very large degree. Nevertheless the proposed food casings are still open to improvement, in particular with a view to an optimum dyeing capability.

In order to enhance the covering capacity of the dyed PO layer and the brilliance of the colors, the innermost PA layer facing the food such as, e.g., sausage stock, is usually dyed white. As the purpose of this PA layer essentially is to ensure an adequate stock adhesion with the packaged food, its layer thickness may be selected to be relatively low. A high percentage of master batch is added such as to obtain adequate dyeing. Besides the reduction of the oxygen barrier, this disadvantageously also results in a reduction of the stock adhesion of the PA layer. Moreover, owing to the small layer thickness, satisfactory dyeing is not possible or only conditionally possible even with high amounts of added pigment.

It accordingly is the object of the present invention to further develop a generic, multilayer, tube-type food film in such a way that an adequately covering dyeing capability may be achieved, while avoiding the drawbacks discussed in the foregoing.

It is one aspect of the invention to further develop a generic, multilayer, tube-type food film such that a reduction of the stock adhesion of the innermost layer contacting the foodstuff is prevented.

It is another aspect of the invention to further develop a generic, multilayer, tube-type food film such that the water vapor diffusion through the film is prevented.

It is another aspect of the invention to further develop a generic, multilayer, tube-type food film such that higher flexibility in the choice of materials for single layers is obtained.

It is another aspect of the invention to further develop a generic, multilayer, tube-type food film such that a long shelf life of the packaged food, in particular foods having a high humidity content, is obtained.

It is another aspect of the invention to further develop a generic, multilayer, tube-type food film such that high mechanical strength, in particular optimum shrinkage and/or a high distension factor, is obtained.

This object is achieved through the food film having the features of at least one of claims 1 and 6 to 13 and the food casing according to claim 19.

In accordance with the invention, a multilayer, tube-type food film, in particular sausage casing is proposed for the first time, wherein the food film is manufactured on a multilayer coextrusion film blow molding system by means of coextruded plastics supplied to a blowing head and stretched biaxially in the triple bubble process. The food film comprises at least six layers, the at least six layers of the food film being arranged from the outside to the inside, as follows:
an outermost layer including a PA as a layer component,
an innermost layer including a PA as a layer component, and
an intermediately arranged succession of at least four intermediate layers which are arranged from the outside to the inside, as follows:
   one layer includes an AP as a layer component,
   another layer includes a PO, preferably PP, as a layer component,
   another layer includes a PO, preferably PP, as a layer component, and
   another layer includes an AP as a layer component.

The two separate, adjacently arranged PO layers advantageously allow for the desired dyeing capability with regard to covering capacity and color brilliance. Thus, it is possible on the one hand to increase the total quantity of pigments that may be introduced. On the other hand, it is made possible by dyeing two different PO layers to utilize pigment types in a food casing which had previously not been combined or could not have been combined. This allows to create new color effects that had hitherto not been obtainable by dyeing of one PO layer only.

It is another advantage of separately dyeing two PO layers that the dye master batches available for this purpose, i.e., dye/additive/combination concentrates or polymer-bound additives such as, e.g., color pigments, are available at lower cost and more easily than the dye master batches suitable for dyeing other polymer layers. Moreover the number of providers of PO dye master batches is clearly higher.

At the same time, due to the two separate PO layers an excellent water vapor barrier is available, which is an advantage particularly with sausage or other foods requiring to be kept fresh. A food packaged with the food casing or film of the invention thus stays fresh for a particularly long time.

Due to the low water vapor permeability, the weight losses during storage of the foods, in particular of sausage, furthermore remain low. This is of considerable economic importance as most foods, in particular sausage, are traded at a sales price determined by weight. Weight losses during the storage period on account of water vapor diffusion through the package lead to a reduction of the achievable turnovers.

In accordance with the invention, the outermost PA layer of the proposed food film is not intended for dyeing. Accordingly, the adhesion of printing inks is not impaired by pigments present at the surface, so that the outermost PA layer is particularly well suited for being inscribed or imprinted.

In accordance with the invention, the traditionally performed dyeing of the innermost PA layer moreover is not required, whereby the drawbacks of a reduced oxygen barrier and degraded stock adhesion as described in the foregoing are avoided. The food film thus is particularly well suited as a sausage casing, for its innermost PA layer presents particularly good stock adhesion with the sausage stock in the layer structures presently proposed for the first time. Especially when packaged by means of the food film of the invention, sausage presents a wrinkle-free, closely fitting casing even after prolonged storage. Interstices do not form between the sausage stock and the innermost layer of the sausage casing thanks to the particularly good stock adhesion, whereby settling of jelly from the sausage stock is avoided.

Advantageous developments of the food film of the invention are subject matter of dependent claims 2 to 5 and 14 to 19.

Thus, the at least four intermediate layers may be placed in directly adjacent succession.

This results in a compact and cost-efficient layer structure having a total of six layers which realizes the advantages mentioned in the foregoing. It is moreover characterized by easy manufacture.

The food film may include at least one additional layer arranged, in the case of the at least four intermediate layers, between the two intermediate layers including PO as a layer component, with this at least one additional layer including an AP or an EVOH or ethylene-vinyl alcohol copolymer or a PA as a layer component.

The use of an additional layer in the form of an AP arranged between the two PO layers of the four intermediate layers allows for an even better interlayer adhesion between these layers. This in turn allows the use of two substantially different PO's, and thus higher flexibility in the choice of the materials for the two PO layers at a concurrently good interlayer adhesion.

Moreover the at least one additional layer arranged between the two intermediate layers including PO as a layer component may either be a succession of three layers, of which
one layer includes an AP as a layer component,
another layer includes an EVOH as a layer component, and
another layer includes an AP as a layer component,
   or is a succession of five layers, of which
one layer includes an AP as a layer component,
another layer includes a PA as a layer component,
another layer includes an EVOH as a layer component,
another layer includes a PA as a layer component, and
another layer includes an AP as a layer component.

As was found in extended studies, an oxygen permeation of less than 10 cm³/(m²·day·bar) that is desirable for food packagings will be achieved through a separate high-barrier layer such as, e.g., EVOH or ethylene-vinyl alcohol copolymer, respectively.

In addition, the arrangement of the EVOH layer between two AP layers, which in turn are arranged between the two PO layers, provides further improved protection of the EVOH layer against humidity and other external influences. Hereby an adequate barrier effect against humidity is obtained even if the AP is used in the form of a thin layer, which is particularly advantageous in view of the high price of the AP's.

Particularly when the food film of the invention is used as a sausage casing, the mechanical strength is of considerable importance. Not only strength but also the barrier properties discussed in the foregoing are essentially dependent on the interlayer adhesion of the single layers among each other.

As the composite of films is subjected to extraordinarily high mechanical strain by the biaxial stretching process during manufacture, it is only conditionally possible with the presently available AP's to achieve optimum adhesion of the AP with the EVOH layer. As it is, however, possible to obtain very good adhesion with the PA layers with the aid of AP, and PA in turn enters into excellent adhesion with the EVOH layer, it is possible to obtain further improved, optimum interlayer adhesion by embedding the EVOH layer between two additional PA layers.

In addition, between the outermost layer of PA and the succession of the at least four intermediate layers on the basis of AP, PO, PO, AP, the food film may comprise at least two further layers on the basis of PA or EVOH or AP, wherein the latter comprise, from the outside to the inside, either preferably
one layer including an EVOH as a layer component, and
one layer including a PA as a layer component, or preferably
one layer including an AP as a layer component,
one layer including an EVOH as a layer component, and
one layer including a PA as a layer component.

As the oxygen barrier of EVOH or ethylene-vinyl alcohol copolymer, respectively, is reduced by absorption of humidity, EVOH is advantageously arranged in the outer range of the layered composite in the above-described layer structure. Namely, the PO layers located further to the inside then offer adequate protection for the EVOH layer against humidity from the packaged food.

As PA and EVOH enter into very good interlayer adhesion with each other, the EVOH layer may be applied directly onto a PA layer without an additional AP.

In some applications it may moreover be necessary to also protect the humidity-sensitive EVOH layer against humidity penetrating from the outside. In view of the fact that most AP's are PO-based, they also offer protection against penetrating humidity. Arranging an AP layer between the outermost layer and the EVOH layer thus allows to provide even better protection against humidity from the outside. The effectiveness of the EVOH oxygen barrier may thus be preserved.

In a preferred embodiment the brightness gain of the dyed food film of the invention may be in a range from 5 to 20%, preferably from 6 to 15%, in particular from 7 to 10% in comparison with a standard 5-layer film. Moreover the brilliance gain of a preferred embodiment may be in a range from 8 to 30%, preferably from 9 to 25%, in particular from 10 to 15% in comparison with a standard 5-layer film. This advantage of the food film of the invention becomes evident from the following exemplary comparison:
A) Standard sausage casing (5 layers with layer sequence PA∥AP∥PO∥AP∥PA)

| Light type/Observer conditions | Brightness L* | Brilliance C* |
|---|---|---|
| 1) D65 10 Deg | 47.43 | 56.56 |
| 2) F11 10 Deg | 51.08 | 59.30 |
| 3) A 10 Deg | 54.70 | 66.18 |

B) Sausage casing of the invention with separately dyed PO layers (here, e.g., 7 layers with layer sequence PA∥AP∥PO∥AP∥PO∥AP∥PA)

| Light type/Observer conditions | Brightness L* | Brilliance C* |
|---|---|---|
| 1) D65 10 Deg | 51.02 | 64.04 |
| 2) F11 10 Deg | 56.14 | 68.01 |
| 3) A 10 Deg | 59.32 | 73.04 |

C) Difference between standard sausage casing according to A) and exemplary sausage casing of the invention according to B)

| Light type/Observer conditions | Brightness L* | Brilliance C* |
|---|---|---|
| 1) D65 10 Deg | +3.60 (+7.57%) | +7.48 (+13.22%) |
| 2) F 11 10 Deg | +5.06 (+9.91%) | +8.71 (+14.69%) |
| 3) A 10 Deg | +4.62 (+8.45%) | +6.86 (+10.37%) |

Light type/Observer conditions:
1) D65 10 Deg=daylight 300 Nm-700 Nm;
2) F11 10 Deg=fluorescent tubes, very high energy emissions at the wavelengths of 400 Nm, 550 Nm and 640 Nm; and
3) A 10 Deg=standard household incandescent lamp, virtually no UV radiation, hardly blue proportions, but instead a high red proportion.

Used measurement method: CIE L*a*b color difference standard.

It is thus possible in accordance with the invention to realize a food film and in particular a sausage casing possessing an optimum dyeing capability at concurrently a first-class print image. This in turn opens up substantially more options for designing the optical appearance of the food film than had hitherto existed.

Shrinkage of the food film may be in a range from 5 to 30%, preferably from 12 to 15%. The distension factor of the food film may be in a range from 2 to 20%, preferably from 10 to 12%.

The multilayer structures of the invention advantageously realize food films, in particular sausage casings, which present mechanical properties appropriate for the respective purpose of use, such as optimum shrinkage and optimum distension factor.

For some applications a longest possible shelf life of the packaged food is needed. This requires a highest possible oxygen barrier, which can not be achieved with the PA layers or any mixtures in these layers.

Thus, the oxygen permeability in conventional PA structures without EVOH is about 26 to 29 cm³/(m²·day·bar) at 23° C. and 0% relative humidity, or about 32 to 34 cm³/(m²·day·bar) at 23° C. and 85% relative humidity (measured according to ISO 15 105-1). This value is independent of whether the food film is 3-, 5- or 7-layered.

On the other hand, the oxygen permeability of the food film of the invention in an advantageous embodiment may be less than 10 cm³/(m²·day·bar), preferably less than or equal to 3 cm³/(m²·day·bar) at 23° C. and 0% relative humidity and/or less than or equal to 9 cm³/(m²·day·bar) at 23° C. and 85% relative humidity (measured according to ISO 15 105-1).

The use of an EVOH layer thus allows to achieve a considerably reduced oxygen permeation through the food film while preserving the advantages discussed in the foregoing.

In another advantageous embodiment, the water vapor permeability of the food film may be less than 3 g/(m²·day·bar), in particular in a range from about 1.5 to 2.5 g/(m²·day·bar), at 23° C. and 50% relative humidity (measured according to ISO 15 106-1).

Thanks to the low water vapor permeability of the food film of the invention, a humidity-sensitive EVOH layer may effectively be protected against humidity. Hereby a high oxygen barrier of the EVOH layer and thus of the whole food film is obtained. In addition, the packaged food is protected against desiccation and weight loss is avoided, as was discussed in the foregoing.

The food film of the invention lends itself particularly well to manufacture and further processing with the aid of corresponding systems by the same applicant.

Particularly advantageous embodiments of the food film of the invention are described in claims 6 to 13, as follows:

In accordance with the invention a multilayer, tube-type food film, in particular sausage casing is proposed, wherein the food film is manufactured on a multilayer coextrusion film blow molding system by means of coextruded plastics supplied to a blowing head and stretched biaxially in the triple bubble process. The food film comprises at least six layers, the layers of the food film being arranged in a succession from the outside to the inside, as follows: a first layer from the outside, i.e., the outermost layer including a PA as a layer component; a second layer from the outside including an AP as a layer component; a third layer from the outside including a PO, preferably PP, as a layer component; a fourth layer from the outside including a PO, preferably PP, as a layer component; a fifth layer from the outside including an AP as a layer component; and a sixth layer from the outside, i.e., the innermost layer, including a PA as a layer component.

Moreover in accordance with the invention a multilayer, tube-type food film, in particular sausage casing is proposed, wherein the food film is manufactured on a multilayer coextrusion film blow molding system by means of coextruded plastics supplied to a blowing head and stretched biaxially in the triple bubble process. The food film comprises at least seven layers, the layers of the food film being arranged in a succession from the outside to the inside, as follows: a first layer from the outside, i.e., the outermost layer, including a PA as a layer component; a second layer from the outside including an AP as a layer component; a third layer from the outside including a PO, preferably PP, as a layer component; a fourth layer from the outside including an AP as a layer component; a fifth layer from the outside including a PO, preferably PP, as a layer component; a sixth layer from the outside including an AP as a layer component; and a seventh layer from the outside, i.e., the innermost layer, including a PA as a layer component.

Moreover, in accordance with the invention a multilayer, tube-type food film, in particular sausage casing is proposed, wherein the food film is manufactured on a multilayer coextrusion film blow molding system by means of coextruded plastics supplied to a blowing head and stretched biaxially in the triple bubble process. The food film comprises at least eight layers, the layers of the food film being arranged in a succession from the outside to the inside, as follows: a first layer from the outside, i.e., the outermost layer, including a PA as a layer component; a second layer from the outside including EVOH or ethylene-vinyl alcohol copolymer, respectively, as a layer component; a third layer from the outside including a PA as a layer component; a fourth layer from the outside including an AP as a layer component; a fifth layer from the outside including a PO, preferably PP, as a layer component; a sixth layer from the outside including a PO, preferably PP, as a layer component; a seventh layer from the outside including an AP as a layer component; and an eighth layer from the outside, i.e., the innermost layer, including a PA as a layer component.

In accordance with the invention, a multilayer, tube-type food film, in particular sausage casing is furthermore proposed, wherein the food film is manufactured on a multilayer coextrusion film blow molding system by means of coextruded plastics supplied to a blowing head and stretched biaxially in the triple bubble process. The food film comprises at least nine layers, the layers of the food film being arranged in a succession from the outside to the inside, as follows: a first layer from the outside, i.e., the outermost layer, including a PA as a layer component; a second layer from the outside including EVOH or ethylene-vinyl alcohol copolymer, respectively, as a layer component; a third layer from the outside including a PA as a layer component; a fourth layer from the outside including an AP as a layer component; a fifth layer from the outside including a PO, preferably PP, as a layer component; a sixth layer from the outside including an AP as a layer component; a seventh layer from the outside including a PO, preferably PP, as a layer component; an eighth layer from the outside including an AP as a layer component; and a ninth layer from the outside, i.e., the innermost layer, including a PA as a layer component.

Furthermore a multilayer, tube-type food film, in particular sausage casing is proposed, wherein the food film is manufactured on a multilayer coextrusion film blow molding system by means of coextruded plastics supplied to a blowing head and stretched biaxially in the triple bubble process. The food film comprises at least nine layers, the layers of the food film being arranged in a succession from the outside to the inside, as follows: a first layer from the outside, i.e., the outermost layer, including a PA as a layer component; a second layer from the outside including an AP as a layer component; a third layer from the outside including EVOH as a layer component; a fourth layer from the outside including a PA as a layer component; a fifth layer from the outside including an AP as a layer component; a sixth layer from the outside including a PO, preferably PP, as a layer component; a seventh layer from the outside including a PO, preferably PP, as a layer component; an eighth layer from the outside including an AP as a layer component; and a ninth layer from the outside, i.e., the innermost layer, including a PA as a layer component.

In accordance with the invention, a multilayer, tube-type food film, in particular sausage casing is furthermore proposed, wherein the food film is manufactured on a multilayer coextrusion film blow molding system by means of coextruded plastics supplied to a blowing head and stretched biaxially in the triple bubble process. The food film comprises at least ten layers, the layers of the food film being arranged in a succession from the outside to the inside, as follows: a first layer from the outside, i.e., the outermost layer, including a PA as a layer component; a second layer from the outside including an AP as a layer component; a third layer from the outside including EVOH as a layer component; a fourth layer from the outside including a PA as a layer component; a fifth layer from the outside including an AP as a layer component; a sixth layer from the outside including a PO, preferably PP, as a layer component; a seventh layer from the outside including an AP as a layer component; an eighth layer from the outside including a PO, preferably PP, as a layer component; a ninth layer from the outside including an AP as a layer component; and a tenth layer from the outside, i.e., the innermost layer, including a PA as a layer component.

Furthermore a multilayer, tube-type food film, in particular sausage casing is proposed, wherein the food film is manufactured on a multilayer coextrusion film blow molding sys tem by means of coextruded plastics supplied to a blowing head and stretched biaxially in the triple bubble process. The food film comprises at least nine layers, the layers of the food film being arranged in a succession from the outside to the inside, as follows: a first layer from the outside, i.e., the outermost layer, including a PA as a layer component; a second layer from the outside including an AP as a layer component; a third layer from the outside including a PO, preferably PP, as a layer component; a fourth layer from the outside including an AP as a layer component; a fifth layer from the outside including EVOH as a layer component; a sixth layer from the outside including an AP as a layer component; a seventh layer from the outside including a PO, preferably PP, as a layer component; an eighth layer from the outside including an AP as a layer component; and a ninth layer from the outside, i.e., the innermost layer, including a PA as a layer component.

In accordance with the invention, a multilayer, tube-type food film, in particular sausage casing is furthermore proposed, wherein the food film is manufactured on a multilayer coextrusion film blow molding system by means of coextruded plastics supplied to a blowing head and stretched biaxially in the triple bubble process. The food film comprises at least eleven layers, the layers of the food film being arranged in a succession from the outside to the inside, as follows: a first layer from the outside, i.e., the outermost layer, including a PA as a layer component; a second layer from the outside including an AP as a layer component; a third layer from the outside including a PO, preferably PP, as a layer component; a fourth layer from the outside including an AP as a layer component; a fifth layer from the outside including a PA as a layer component; a sixth layer from the outside including EVOH as a layer component; a seventh layer from the outside including a PA as a layer component; an eighth layer from the outside including an AP as a layer component; a ninth layer from the outside including a PO, preferably PP, as a layer component; a tenth layer from the outside including an AP as a layer component; and an eleventh layer from the outside, i.e., the innermost layer, including a PA as a layer component.

Furthermore a multilayer, planar food casing is proposed which is produced of a multilayer, tube-type food film in accordance with the present invention cut open for this purpose. This food casing presents all the advantages of the food casing of the invention.

Besides the practical examples having been explained, the invention also admits further configuring approaches.

Within the meaning of the present application, PO may be a substance selected from a group consisting of PP, PE, polyolefin plastomer (in brief: POP), ethylene-vinyl acetate copolymers (in brief: EVAC), ethylene-methylmethacrylate copolymers (in brief: EMMA), ethylene-methacrylic acid copolymers (in brief: EMA), ethylene-acrylic acid copolymers (in brief: EAA), copolymers of cycloolefins/cycloalkenes and 1-alkenes or cycloolefin copolymers (in brief: COC), or a mixture of these. Moreover PO may be a mixture of the above PO with ionomers.

AP designates adhesive layers bringing about good interlayer adhesion of the single layers among each other. AP may be based on a base substance selected from a group consisting of PE, PP, EVAC, EMA, EMMA, EAA and an ionomer, or a mixture of these.

In accordance with another preferred embodiment, layers including AP as a layer component may also include a blend of PO and AP or a blend of EVAC, EMA, EMMA and/or EAA and AP or a blend of ionomer and AP or a blend of a plurality of AP's.

Furthermore it may be provided that layers including EVOH as a layer component include not EVOH but instead a modified PA of m-xylylenediamine and adipic acid (in brief: MXD6) or PVOH.

According to a further embodiment it may be provided that layers including EVOH or PVOH or MXD6 include blends of these substances or blends of these substances with PA.

In accordance with the invention, PA may be a substance selected from a group consisting of PA of ε-caprolactam or poly(s-caprolactam) (in brief: PA6), PA of hexamethylene diamine and adipic acid or polyhexamethylene adipamide (in brief: PA6.6), PA of ε-caprolactam and hexamethylene diamine/adipic acid (in brief: PA6.66), PA of hexamethylene diamine and dodecanedioic acid or polyhexamethylene dodecanamide (in brief: PA6.12), PA of 11-aminoundecanoic acid or polyundecanamide (in brief: PA11), PA of 12-laurinlactam or poly(ω-laurinlactam) (in brief: PA12), or a blend of these PA's or a blend of these PA's with amorphous PA or with other polymers. The general notation PAx.y synonymously represents PAx/y or PAxy.

It may moreover be provided that layers comprising PA as a layer component include not PA but instead a MXD6 or ionomer.

In accordance with another embodiment it may be provided that layers including PA or MXD6 include blends of PA and EVOH or PA and PVOH or PA and MXD6.

The layer of the food film of the invention referred to as the innermost layer in the present description is in contact with the food to be packaged, in particular a sausage stock. The layer of the food film of the invention referred to as the outermost layer in the present description seals the food film against the environment.

Within the meaning of the present invention, the designation of a material as a “layer component” indicates that a layer of the food film of the invention at least partly includes such material. Within the meaning of the present invention, the designation “layer component” may in particular embrace a layer to be comprised entirely of such material.

1. A multilayer, tube-type food film, in particular sausage casing, wherein the food film is manufactured on a multilayer coextrusion film blow molding system by means of coextruded plastics supplied to a blowing head and stretched biaxially in the triple bubble process, characterized in that the food film comprises:
at least six layers, the at least six layers of the food film being arranged from the outside to the inside, as follows:
an outermost layer including a polyamide as a layer component,
an innermost layer including a polyamide as a layer component, and
an intermediately arranged succession of at least four intermediate layers which are arranged from the outside to the inside, as follows:
one layer includes an adhesion promoter as a layer component,
another layer includes a polyolefin as a layer component,
another layer includes a polyolefin as a layer component, and
another layer includes an adhesion promoter as a layer component.

2. The multilayer, tube-type food film according to claim 1, characterized in that the at least four intermediate layers are placed in directly adjacent succession.

3. The multilayer, tube-type food film according to claim 1, characterized in that the food film comprises at least one additional layer arranged, in the case of the at least four intermediate layers, between the two intermediate layers including polyolefin (PO) as a layer component, with this at least one additional layer including an adhesion promoter or an ethylene-vinyl alcohol copolymer or a polyamide as a layer component.

4. The multilayer, tube-type food film according to claim 3, characterized in that the at least one additional layer arranged between the two intermediate layers including polyolefin as a layer component is either a succession of three layers, of which
one layer includes an adhesion promoter as a layer component,
another layer includes an ethylene-vinyl alcohol copolymer as a layer component, and
another layer includes an adhesion promoter as a layer component,
or
a succession of five layers, of which
one layer includes an adhesion promoter as a layer component,
another layer includes a polyamide as a layer component,
another layer includes an ethylene-vinyl alcohol copolymer as a layer component,
another layer includes a polyamide as a layer component, and
another layer includes an adhesion promoter as a layer component.

5. The multilayer, tube-type food film according to claim 1, characterized in that between the outermost layer of polyamide and the succession of the at least four intermediate layers on the basis of adhesion promoter, polyolefin, polyolefin, adhesion promoter, at least two additional layers on the basis of polyamide or ethylene-vinyl alcohol copolymer or adhesion promoter are arranged, wherein the latter comprise, from the outside to the inside,
either preferably
one layer including an ethylene-vinyl alcohol copolymer as a layer component, and
one layer including a polyamide as a layer component, or preferably
one layer including an adhesion promoter as a layer component,
one layer including an ethylene-vinyl alcohol copolymer as a layer component, and
one layer including a polyamide as a layer component.

6. A multilayer, tube-type food film, in particular sausage casing, wherein the food film is manufactured on a multilayer coextrusion film blow molding system by means of coextruded plastics supplied to a blowing head and stretched biaxially in the triple bubble process, characterized in that the food film comprises:
at least six layers, the layers of the food casing being arranged in a succession from the outside to the inside, as follows:
a first layer from the outside including a polyamide as a layer component;
a second layer from the outside including an adhesion promoter as a layer component;
a third layer from the outside including a polyolefin, preferably polypropylene, as a layer component;
a fourth layer from the outside including a polyolefin, preferably polypropylene, as a layer component;
a fifth layer from the outside including an adhesion promoter as a layer component; and
a sixth layer from the outside including a polyamide as a layer component.

7. A multilayer, tube-type food film, in particular sausage casing, wherein the food film is manufactured on a multilayer coextrusion film blow molding system by means of coextruded plastics supplied to a blowing head and stretched biaxially in the triple bubble process, characterized in that the food film comprises:
at least seven layers, the layers of the food film being arranged in a succession from the outside to the inside, as follows:
a first layer from the outside including a polyamide as a layer component;
a second layer from the outside including an adhesion promoter as a layer component;
a third layer from the outside including a polyolefin, preferably polypropylene, as a layer component;
a fourth layer from the outside including an adhesion promoter as a layer component;
a fifth layer from the outside including a polyolefin, preferably polypropylene, as a layer component;
a sixth layer from the outside including an adhesion promoter as a layer component; and
a seventh layer from the outside including a polyamide as a layer component.

8. A multilayer, tube-type food film, in particular sausage casing, wherein the food film is manufactured on a multilayer coextrusion film blow molding system by means of coextruded plastics supplied to a blowing head and stretched biaxially in the triple bubble process, characterized in that the food film comprises:
at least eight layers, the layers of the food film being arranged in a succession from the outside to the inside, as follows:
a first layer from the outside including a polyamide as a layer component;
a second layer from the outside including an ethylene-vinyl alcohol copolymer as a layer component;
a third layer from the outside including a polyamide as a layer component;
a fourth layer from the outside including an adhesion promoter as a layer component;
a fifth layer from the outside including a polyolefin, preferably polypropylene, as a layer component;
a sixth layer from the outside including a polyolefin, preferably polypropylene, as a layer component;
a seventh layer from the outside including an adhesion promoter as a layer component; and
an eighth layer from the outside including a polyamide as a layer component.

9. A multilayer, tube-type food film, in particular sausage casing, wherein the food film is manufactured on a multilayer coextrusion film blow molding system by means of coextruded plastics supplied to a blowing head and stretched biaxially in the triple bubble process, characterized in that the food film comprises:
at least nine layers, the layers of the food film being arranged in a succession from the outside to the inside, as follows:
a first layer from the outside including a polyamide as a layer component;
a second layer from the outside including an ethylene-vinyl alcohol copolymer as a layer component;
a third layer from the outside including a polyamide as a layer component;
a fourth layer from the outside including an adhesion promoter as a layer component;
a fifth layer from the outside including a polyolefin, preferably polypropylene, as a layer component;
a sixth layer from the outside including an adhesion promoter as a layer component;
a seventh layer from the outside including a polyolefin, preferably polypropylene, as a layer component;
an eighth layer from the outside including an adhesion promoter as a layer component; and
a ninth layer from the outside including a polyamide as a layer component.

10. A multilayer, tube-type food film, in particular sausage casing, wherein the food film is manufactured on a multilayer coextrusion film blow molding system by means of coextruded plastics supplied to a blowing head and stretched biaxially in the triple bubble process, characterized in that the food film comprises:
at least nine layers, the layers of the food film being arranged in a succession from the outside to the inside, as follows:
a first layer from the outside including a polyamide as a layer component;
a second layer from the outside including an adhesion promoter as a layer component;
a third layer from the outside including an ethylene-vinyl alcohol copolymer as a layer component;
a fourth layer from the outside including a polyamide as a layer component;
a fifth layer from the outside including an adhesion promoter as a layer component;
a sixth layer from the outside including a polyolefin, preferably polypropylene, as a layer component;
a seventh layer from the outside including a polyolefin, preferably polypropylene, as a layer component;
an eighth layer from the outside including an adhesion promoter as a layer component; and
a ninth layer from the outside including a polyamide as a layer component.

11. A multilayer, tube-type food film, in particular sausage casing, wherein the food film is manufactured on a multilayer coextrusion film blow molding system by means of coextruded plastics supplied to a blowing head and stretched biaxially in the triple bubble process, characterized in that the food film comprises:
at least ten layers, the layers of the food film being arranged in a succession from the outside to the inside, as follows:
a first layer from the outside including a polyamide as a layer component;
a second layer from the outside including an adhesion promoter as a layer component;
a third layer from the outside including an ethylene-vinyl alcohol copolymer as a layer component;
a fourth layer from the outside including a polyamide as a layer component;
a fifth layer from the outside including an adhesion promoter as a layer component;
a sixth layer from the outside including a polyolefin, preferably polypropylene, as a layer component;
a seventh layer from the outside including an adhesion promoter as a layer component;
an eighth layer from the outside including a polyolefin, preferably polypropylene, as a layer component;
a ninth layer from the outside including an adhesion promoter as a layer component; and
a tenth layer from the outside including a polyamide as a layer component.

12. A multilayer, tube-type food film, in particular sausage casing, wherein the food film is manufactured on a multilayer coextrusion film blow molding system by means of coextruded plastics supplied to a blowing head and stretched biaxially in the triple bubble process, characterized in that the food film comprises:
at least nine layers, the layers of the food film being arranged in a succession from the outside to the inside, as follows:
a first layer from the outside including a polyamide as a layer component;
a second layer from the outside including an adhesion promoter as a layer component;
a third layer from the outside including a polyolefin, preferably polypropylene, as a layer component;
a fourth layer from the outside including an adhesion promoter as a layer component;
a fifth layer from the outside including an ethylene-vinyl alcohol copolymer as a layer component;
a sixth layer from the outside including an adhesion promoter as a layer component;
a seventh layer from the outside including a polyolefin, preferably polypropylene, as a layer component;
an eighth layer from the outside including an adhesion promoter as a layer component; and
a ninth layer from the outside including a polyamide as a layer component.

13. A multilayer, tube-type food film, in particular sausage casing, wherein the food film is manufactured on a multilayer coextrusion film blow molding system by means of coextruded plastics supplied to a blowing head and stretched biaxially in the triple bubble process, characterized in that the food film comprises:
at least eleven layers, the layers of the food film being arranged in a succession from the outside to the inside, as follows:
a first layer from the outside including a polyamide as a layer component;
a second layer from the outside including an adhesion promoter as a layer component;
a third layer from the outside including a polyolefin, preferably polypropylene, as a layer component;
a fourth layer from the outside including an adhesion promoter as a layer component;
a fifth layer from the outside including a polyamide as a layer component;
a sixth layer from the outside including an ethylene-vinyl alcohol copolymer as a layer component;
a seventh layer from the outside including a polyamide as a layer component;
an eighth layer from the outside including an adhesion promoter as a layer component;
a ninth layer from the outside including a polyolefin, preferably polypropylene, as a layer component;
a tenth layer from the outside including an adhesion promoter as a layer component; and
an eleventh layer from the outside including a polyamide as a layer component.

14. The multilayer, tube-type food film according to claim 1, characterized in that the brightness gain of the dyed food film is in a range from 5 to 20%, preferably from 6 to 15%, in particular from 7 to 10%, and/or the brilliance gain of the dyed food film is in a range from 8 to 30%, preferably from 9 to 25%, in particular from 10 to 15%, in contrast with a standard 5-layer film.

15. The multilayer, tube-type food film according to claim 1, characterized in that shrinkage of the food film is in a range from 5 to 30%, preferably from 12 to 15%.

16. The multilayer, tube-type food film according to claim 1, characterized in that the distension factor of the food film is in a range from 2 to 20%, preferably from 10 to 12%.

17. The multilayer, tube-type food film according to claim 1, characterized in that the oxygen permeability of the food film is less than 10 cm³/(m²·day·bar), preferably less than or equal to 3 cm³/(m²·day·bar) at 23° C. and 0% relative humidity and/or less than or equal to 9 cm³/(m²·day·bar) at 23° C. and 85% relative humidity.

18. The multilayer, tube-type food film according to claim 1, characterized in that the water vapor permeability of the food film is less than 3 g/(m²·day·bar), in particular in a range from about 1.5 to 2.5 g/(m²·day·bar) at 23° C. and 50% relative humidity.

19. A multilayer, planar food casing manufactured of a multilayer, tube-type food film according to claim 1 cut open for this purpose.
